(19) United States
(12) Patent Application Publication
(10) Pub. No.: US 2026/0213952 A1
(43) Pub. Date: Jul. 23, 2026

(54) VISUAL SECURITY ENCRYPTION METHOD, SYSTEM, AND DEVICE BASED ON COLOR TRAFFIC IMAGES

(71) Applicant: DALIAN UNIVERSITY, DALIAN (CN)

(72) Inventors: QIANG ZHANG, DALIAN (CN); BIN WANG, DALIAN (CN); SHUO ZHANG, DALIAN (CN); FENG MIAO, DALIAN (CN); XIAOPENG WEI, DALIAN (CN); SHIHUA ZHOU, DALIAN (CN)

(73) Assignee: DALIAN UNIVERSITY, DALIAN (CN)

(21) Appl. No.: 19/060,985

(22) Filed: Feb. 24, 2025

Related U.S. Application Data
(63) Continuation of application No. PCT/CN2025/073592, filed on Jan. 21, 2025.

(51) Int. Cl. H04L 9/32; G06T 9/00

(52) U.S. Cl. CPC H04L 9/3242; G06T 9/00

(57) ABSTRACT

This application discloses a visual security encryption method, system, and device based on color traffic images, which pertains to the field of visual security technology. The method involves performing Discrete Wavelet Transform (DWT) sparsification on the color traffic image to be encrypted. The sparsified image is then subjected to three-dimensional spiral scrambling. Next, the measurement matrix generated by the improved two-dimensional Logistic chaotic system is optimized through Singular Value Decomposition (SVD) and column vector normalization. Afterward, the scrambled image undergoes compression measurement to obtain the compressed image. Finally, the carrier image undergoes Inverse Wavelet Transform (IWT) decomposition, and the compressed image is embedded into the least significant bit (LSB) of the carrier image.

### TECHNICAL FIELD

The present application relates to the field of visual security technology, and specifically to a visual security encryption method, system, and device based on color traffic images.

### BACKGROUND

In modern society, the acquisition and application of traffic images have become critical components in areas such as traffic management, safety monitoring, and traffic flow analysis. The collection and processing of traffic images are essential for improving the efficiency of traffic systems, ensuring road safety, and enhancing urban transportation. However, with the widespread dissemination and sharing of traffic image data, corresponding information security issues have increasingly attracted attention. The information security challenges faced mainly include the following aspects:
(1) Privacy Leakage: Traffic images may contain sensitive information such as vehicle license plate numbers, vehicle models, and driver identities. If such information is accessed or leaked by unauthorized individuals, it may lead to serious privacy violations.
(2) Data Tampering: Traffic image data may be tampered with or forged during transmission and storage, potentially resulting in false traffic incident reports or misleading traffic management systems.
(3) Denial of Service Attacks: Malicious attackers may attempt to disrupt the normal operation of traffic monitoring systems through denial-of-service attacks (e.g., flood attacks), leading to traffic congestion and safety risks.

Image encryption, as an important privacy protection technology, has garnered significant attention in recent years. Current image encryption techniques often integrate other technologies to enhance encryption security, such as chaos theory, DNA encoding, optical transformation, and cellular automata. Although these technologies can prevent ciphertext data from being directly accessed, noise-like ciphertext is more likely to expose the importance of the protected content, failing to ensure the visual security of the ciphertext. Therefore, how to improve the visual security of ciphertext to prevent it from being exposed during transmission has become an urgent problem to be solved in current encryption technologies.

### SUMMARY

The objective of the present application is to propose a visual security encryption method, system, and device based on color traffic images.

According to a first aspect of the embodiments of the present disclosure, a visual security encryption method based on color traffic images is provided, comprising the following steps:
generating parameters and initial values for a two-dimensional chaotic map based on color traffic image information;
performing sparsification processing on the color traffic image;
generating a measurement matrix via a chaotic system and optimizing the measurement matrix using singular value decomposition (SVD) and column vector normalization;
applying three-dimensional spiral scrambling to the sparsified color traffic image to obtain an encrypted image;
compressing the encrypted image using the optimized measurement matrix to obtain a compressed encrypted image;
performing an integer wavelet transform (IWT) on a carrier image and embedding the compressed encrypted image into the least significant bits of the high-frequency components (LL, LH, HL) of the carrier image to generate the final encrypted image.

According to a second aspect of the embodiments of the present disclosure, a visual security encryption system based on color traffic images is provided, comprising:
a parameter acquisition module configured to generate parameters and initial values for a two-dimensional chaotic map based on color traffic image information;
a sparsification module configured to perform sparsification processing on the color traffic image;
an optimization module configured to generate a measurement matrix via a chaotic system and optimize the measurement matrix using SVD and column vector normalization;
a scrambling module configured to apply three-dimensional spiral scrambling to the sparsified color traffic image to generate an encrypted image;
a compression module configured to compress the encrypted image using the optimized measurement matrix;
an encryption module configured to perform IWT on a carrier image and embed the compressed encrypted image into the least significant bits of the high-frequency components (LL, LH, HL) of the carrier image to generate the final encrypted image.

According to a third aspect of the embodiments of the present disclosure, an electronic device is provided, comprising a memory, a processor, and a computer program stored on the memory and executable by the processor, wherein the processor, when executing the program, implements the visual security encryption method based on color traffic images as described above.

According to a fourth aspect of the embodiments of the present disclosure, a computer-readable storage medium is provided, having a computer program stored thereon, wherein the program, when executed by a processor, implements the visual security encryption method based on color traffic images as described above.

### BRIEF DESCRIPTION OF THE DRAWINGS

The drawings that form part of this application are provided to further illustrate the understanding of the application. The exemplary embodiments and their descriptions are used to explain the application and do not constitute improper limitations of the application.

FIG. 1 is a schematic diagram of a three-dimensional spiral scrambling method;

FIG. 2 is a diagram of an overall encryption framework;

FIG. 3 is a diagram of a decryption framework.

### DETAILED DESCRIPTION

The drawings in this application are provided to further illustrate the technical solutions of the embodiments of the application. It is evident that the described embodiments are only part of the embodiments of this application, not all of them. Any other embodiments derived by those skilled in the art based on the embodiments in this application, without any creative effort, fall within the scope of protection of this application.

To make the objectives, features, and advantages of this application more apparent and understandable, a further detailed description of this application is provided below with reference to the drawings and specific embodiments.

In the following embodiments, the external key “Secretkey” is set to: 7f4e9f6847484a87826d30a76b6522479b3e6128df984ad0c91b1711c52176c1, TS=25, CR=0.25, the reconstruction algorithm is SLO, and the sampling rate is set to 0.25. The used chaotic map is an improved 2D Logistic chaotic map:

$$\{ \begin{matrix}{X}_{n + 1} = sin ( π ( 4 {aX}_{n} ( 1 - {X}_{n} ) ) + ( 1 - a ) sin ( π {Y}_{n} ) ) \\ {Y}_{n + 1} = sin ( π ( 4 {aY}_{n} ( 1 - {Y}_{n} ) ) + ( 1 - a ) sin ( π {X}_{n + 1}^{2} ) )\end{matrix}$$

where, Xn and Yn represent the two output state variables of the chaotic system.

### Embodiment 1

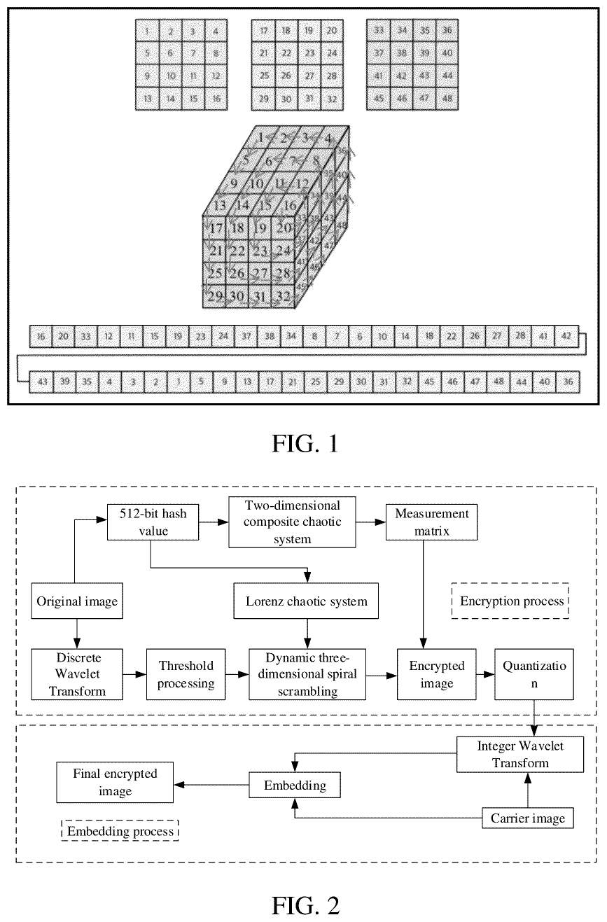

As shown in FIG. 2, this embodiment provides a visual security encryption method based on color traffic images, which includes the following steps:

Step 1: Generate parameters and initial values for the 2D chaotic map based on the color traffic image information.

Specifically, using the SHA-512 function, a 512-bit hash key “KeyVal” is obtained from the original color traffic image. The hash key “KeyVal” is then XORed with an external key “KeyHex” to obtain the key “H”. The key “H” is then used to generate 8 sub-keys “k” using the following equation:

$$k ( i ) = \sqrt[8]{H ( i ) ⊕ H ( i + 1 ) ⊕ H ( i + 2 ) ⊕ H ( i + 3 )} , i = 1 , 2 , … , 8 ;$$

where ⊕ denotes a bitwise XOR operation, k(i) is the ith sub-key, and H(i) is the ith key.

Using the sub-keys k, the parameters a, delta, and initial values key1 and key2 of the chaotic system are obtained:

$$\{ \begin{matrix}a = mod ( sqrt ( k ( 1 ) \times k ( 2 ) ) , 5 ) \\ key 1 = mod ( sqrt ( k ( 3 ) \times k ( 4 ) ) , 5 ) + 20 \\ key 2 = mod ( sqrt ( k ( 5 ) \times k ( 6 ) ) , 1 ) \\ delta = mod ( sqrt ( k ( 7 ) \times k ( 8 ) ) \times row , 5 ) + 0.5\end{matrix}$$

where “row” denotes the number of rows in the image matrix.

Step 2: Sparse processing of the color traffic image.

Specifically, the three channels of the original color traffic image are decomposed into channels Iᵣ, I_{g}, and I_{b}. Discrete Wavelet Transform (DWT) is applied to each channel to obtain three sparse matrices. These sparse matrices are then thresholded, and elements below the threshold TS=25 are rewritten as 0, resulting in the sparse channels I′ᵣ, I′_{g}, and I′_{b}. Here, Iᵣ denotes the red channel of the color traffic image, I_{g} denotes the green channel, and I_{b} denotes the blue channel. I′ᵣ, I′_{g}, and I′_{b} represent the sparse channels of the color traffic image.

Step 3: Generate a measurement matrix using the chaotic system, and optimize the measurement matrix using Singular Value Decomposition (SVD) and column vector normalization.

In an exemplary embodiment, the parameters a, key1, and key2 of the chaotic system are iteratively mapped len+N times. The first N sequences are discarded to eliminate the transient effects of the chaotic mapping, resulting in a chaotic sequence X of length len. The chaotic sequence X is then rewritten as a matrix Φ, and the tensor product operation is performed between matrix Φ and an invertible matrix, resulting in a measurement matrix M: M=Φ [symbol] I₂, where I₂ represents the invertible matrix.

Specifically, setting a=0.98, using key1 and key2 to iterate the improved 2D logistic-sine chaotic system for len+1000 times, the first 1000 sequences are discarded to eliminate the transient effects of the chaotic mapping, resulting in a chaotic sequence catSeq of length len, which is processed to obtain the chaotic sequence catDeqcon: catDeqcon(i1)=1+2×catSeq(d×i₁); where i₁ represents the sequence value and d represents the sampling length.

The measurement matrix M is subjected to Singular Value Decomposition (SVD), obtaining the diagonal elements Ei of the diagonal matrix Σ after decomposition. The mean value of the elements in Ei is calculated and assigned to the diagonal elements of Σ to generate Σ′. SVD decomposition is then performed again to obtain the preliminary optimized measurement matrix M′. This step aims to improve the minimum singular value to enhance the column independence of the measurement matrix:

$$M = U Σ {V}^{T} ;$$

Where U and V are orthogonal matrices, U's column vectors are the left singular vectors, and V's column vectors are the right singular vectors.

$$Σ = [ \begin{matrix}{Σ}_{1} & 0 \\ 0 & 0\end{matrix} ] ,$$

$${Σ}_{1} = diag ( {δ}_{1} , {δ}_{2} , … {δ}_{r} ) {δ}_{1} \geq {δ}_{2} \geq … \geq {δ}_{r} > 0 ,$$

and δᵣ is the minimum singular value.

M′=UΣ′V^{T}.

The preliminary optimized measurement matrix M′ is subjected to column vector normalization to obtain the optimized measurement matrix M″, further improving the independence of the column vectors.

Step 4: Perform 3D spiral scrambling on the sparse color traffic image to obtain the encrypted image.

Specifically, set the iteration length, iterate the Lorenz chaotic system to obtain the chaotic sequence z1. The chaotic sequence z1 is then applied to dynamic Arnold scrambling, and dynamic Arnold scrambling is performed on the three channels I′ᵣ, I′_{g}, I′_{b} of the sparse color traffic image to obtain I″ᵣ, I″_{g}, I″_{b}. Here, I″ᵣ represents the red channel of the color traffic image after dynamic Arnold scrambling, I″_{g} represents the green channel, and I″_{b} represents the blue channel.

The three channels I″ᵣ, I″_{g}, I″ of the color traffic image after dynamic Arnold scrambling are treated as the three faces of a cube. Starting from the upper right corner, spiral transformation scrambling is performed to obtain I′″ᵣ, I′″_{g}, I′″_{b}. Here, I′″ᵣ represents the red channel of the color traffic image after spiral scrambling, I′″_{g} represents the green channel, and I′″_{b} represents the blue channel. The process of 3D spiral scrambling is shown in FIG. 1.

Step 5: Compress the encrypted image using the optimized measurement matrix to obtain the compressed encrypted image.

Specifically, the optimized measurement matrix M″ is applied to compress I″ᵣ, I″_{g}, I″_{b}, reducing their size to ¼ of the original dimensions, resulting in the compressed matrices I″ᵣ, I″_{g}, I″_{b}. Here, I″″ᵣ represents the compressed red channel, I″″_{g} represents the compressed green channel, and I″″_{b} represents the compressed blue channel.

Quantization is then applied to the compressed matrices, and the three channels are combined to form the encrypted image S:

$${S}_{r}^{′} = floor [ \frac{255 \times ( {S}_{r} - min ( ) )}{max - min} ] ;$$

where the quantized image is represented as, the compressed image is represented as, min denotes the minimum pixel value, and max denotes the maximum pixel value.

Step 6: Perform Integer Wavelet Transform (IWT) on the carrier image and embed the compressed encrypted image into the least significant bits of the high-frequency part of the carrier image to obtain the final encrypted image.

Specifically, the three channels of the carrier image C are separated into Cᵣ, C_{g}, C_{b}. The IWT transform is applied to the three channels Cᵣ, C_{g}, and C_{b} of the carrier image to obtain the four parts LL, LH, HL, and HH:

[LL, LH, HL, HH]=IWT(C), where Cᵣ represents the red channel of the carrier image, C_{g} represents the green channel, C_{b} represents the blue channel, LL represents the low-frequency information, LH represents the horizontal high-frequency information, HL represents the vertical high-frequency information, and HH represents the diagonal high-frequency information.

The encrypted image S is separated into three channels Sr, Sg, Sb. The i₂ pixel of Sᵣ is rewritten in binary as b8b7b6b5b4b3b2b1, and then the LH, HL, and HH parts of Cᵣ are also rewritten in binary. Subsequently, b2b1 and b4b3 are embedded into the lowest two bits of LH and HL, respectively, and b8b7b6b5 is embedded into the lowest four bits of HH. The other bits remain unchanged, resulting in HH′, LH′, and HL′. The inverse wavelet transform is then applied to obtain the visually secure carrier image C′, where Sᵣ represents the red channel of the encrypted image, S_{g} represents the green channel, S_{b} represents the blue channel, HH′ represents the diagonal high-frequency information after embedding, LH′ represents the horizontal high-frequency information after embedding, and HL′ represents the vertical high-frequency information after embedding.

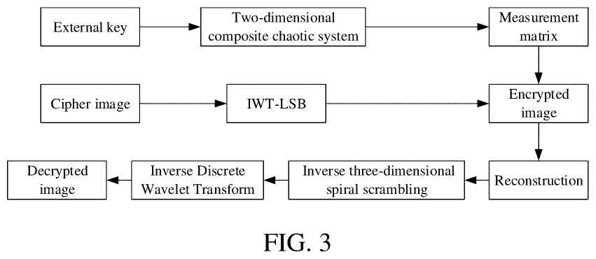

As shown in FIG. 3, the decryption process is the inverse of the encryption process.

This application provides good visual security, with the visual quality of the encrypted images above 42 dB. The encryption is resistant to various common attacks and has high practical value in the secure transmission and storage of traffic images.

The technical solution adopted in this application has the following advantages over the prior art:

A dynamic 3D spiral scrambling method is proposed, which fully utilizes the characteristics of color traffic images. It achieves simultaneous encryption of the three channels, and when combined with chaotic sequences, it further enhances the scrambling performance and increases randomness.

A color traffic image encryption and hiding method based on IWT-LSB is designed. The encrypted image is hidden within a carrier image that is visually meaningful, thereby further strengthening the security performance of the encryption algorithm.

After the encryption embedding process is applied to the original color traffic image, the image can be safely transmitted over a public channel.

This application also provides an application scenario where the above-mentioned visual security encryption method for color traffic images is used. Specifically, the visual security encryption method for color traffic images provided in this embodiment can be applied during the transmission of traffic image data. When transmitting traffic image data, the visual security encryption method provided by this embodiment is used to encrypt the color traffic image. The encrypted image is then transmitted, avoiding the exposure of sensitive information such as license plate numbers, vehicle models, and driver identities in the encrypted image. This not only prevents privacy leakage but also prevents the received image from being tampered with or forged, thereby improving the accuracy of traffic event reporting or traffic management.

### Example 2

This embodiment provides a visual security encryption system based on color traffic images, including:
a parameter acquisition module configured to generate parameters and initial values for a two-dimensional chaotic map based on color traffic image information;
a sparsification module configured to perform sparsification processing on the color traffic image;
an optimization module configured to generate a measurement matrix through a chaotic system, and optimizes the measurement matrix using singular value decomposition and column vector normalization;
a scrambling module configured to perform 3D spiral scrambling on the sparsified color traffic image to obtain an encrypted image;
a compression module configured to compress the encrypted image using the optimized measurement matrix to obtain a compressed encrypted image;
an encryption module configured to perform IWT transformation on the carrier image, embedding the compressed encrypted image into the least significant bits of the high-frequency portion of the carrier image to obtain the final encrypted image.

### Example 3

An electronic device comprising a memory, a processor, and a computer program stored in the memory that, when executed by the processor, implements the visual security encryption method for color traffic images described above.

### Example 4

A computer-readable storage medium storing a computer program, where the program, when executed by a processor, implements the visual security encryption method for color traffic images described above.

Given the increasing challenges of information security in intelligent transportation systems, this application addresses the secure storage and transmission of color traffic images by proposing a visual security image encryption method and system based on P-tensor product compressed sensing combined with IWT-LSB embedding. It solves the current issues of insufficient protection for traffic images and lack of targeted approaches, while also resolving problems in existing visual security image encryption algorithms, such as insufficient visual security, poor robustness, and low-quality reconstructed images. The P-tensor product compressed sensing used in this application can reduce the dimensions of the measurement matrix, thus improving transmission efficiency. Additionally, this method does not require extra storage capacity or transmission bandwidth. The proposed IWT-LSB embedding method embeds the encrypted image into the high-frequency area of the carrier image, significantly enhancing the invisibility of the encrypted image. The simulation was conducted in MATLAB 2020a, with the operating environment being Win10 Intel® CPU 2.3 GHz and ARM 4.0 GB. Tables 1-4 demonstrate that the encryption and decryption effects achieved in this example outperform the experimental effects of other schemes.

TABLE 1
PSNR and MSSIM Values of Simulation Results

| Original | Original | Original | Original | Original | Original |
|---|---|---|---|---|---|
| Image | Image | Image | Image | Image | Image |
| Car1 | bardow1 | 42.8192 | 0.9955 | 31.8147 | 0.9897 |
| Car2 | clinmill | 43.0458 | 0.9942 | 35.8126 | 0.9886 |
| Car3 | Baarnfall | 42.6881 | 0.9964 | 30.3539 | 0.9556 |
| Car4 | malight | 43.1035 | 0.9958 | 25.6191 | 0.9501 |
| Airplane | Babow | 42.7007 | 0.9957 | 35.6037 | 0.9773 |
| Baboon | | | | 35.4307 | 0.9774 |
| Barbara | | | | 35.3607 | 0.9873 |

TABLE 2
Correlation Coefficients of Adjacent Pixels in Encrypted Image

| | | Plain Image | | | Encrypted Image | | |
|---|---|---|---|---|---|---|---|
| Original | Original | Vertical | Vertical | Vertical | Vertical | Vertical | Vertical |
| Image | Image | Direction | Direction | Direction | Direction | Direction | Direction |
| Test | R | 0.9302 | 0.9260 | 0.8745 | 0.0330 | −0.0008 | −0.0262 |
| Image 1 | G | 0.9427 | 0.9334 | 0.8781 | 0.1121 | 0.0088 | −0.0057 |
| | B | 0.9323 | 0.9586 | 0.8976 | 0.1393 | −0.0277 | 0.0323 |
| Test | R | 0.9767 | 0.9836 | 0.9654 | −0.0378 | −0.0265 | 0.0060 |
| Image 2 | G | 0.9715 | 0.9802 | 0.9512 | 0.1140 | −0.0439 | −0.0040 |
| | B | 0.9731 | 0.9829 | 0.9731 | 0.1442 | −0.0388 | −0.0027 |
| Test | R | 0.8826 | 0.9658 | 0.8579 | 0.0210 | 0.0135 | −0.0249 |
| Image 3 | G | 0.9035 | 0.9514 | 0.8924 | 0.0783 | −0.0029 | −0.0011 |
| | B | 0.9078 | 0.9621 | 0.8982 | 0.1346 | −0.0190 | 0.0256 |

TABLE 3
Robustness Analysis of Images Under Noise Attacks

| Encrypted | | | | | | | | | |
|---|---|---|---|---|---|---|---|---|---|
| Image | Gaussian Noise | | | Salt and Pepper Noise | | | Speckle Noise | | |
| | 0.0000001 | 0.0000003 | 0.0000005 | 0.00001 | 0.00003 | 0.00005 | 0.000001 | 0.000003 | 0.000005 |
| Peak | 31.6978 | 29.2722 | 24.7773 | 31.4868 | 31.3129 | 30.8300 | 31.6978 | 26.9079 | 24.4813 |
| Signal- | | | | | | | | | |
| to-Noise | | | | | | | | | |
| Ratio | | | | | | | | | |
| Mean | 0.9556 | 0.9361 | 0.7587 | 0.9508 | 0.9485 | 0.9434 | 0.9527 | 0.8618 | 0.7020 |
| Similarity | | | | | | | | | |

TABLE 4
Robustness Analysis of Images Under Shearing Attack

| Loss Size | Loss Size | Loss Size |
|---|---|---|
| 16*16 | 29.9265 | 0.8894 |
| 32*32 | 27.0984 | 0.8141 |
| 64*64 | 24.8138 | 0.6771 |
| 128*128 | 23.7795 | 0.5156 |

It should be understood by those skilled in the art that each module or step in the above disclosure can be implemented using general-purpose computing devices. Optionally, they can be implemented using program code executable by computing devices, which can be stored in storage devices for execution by the computing devices, or be fabricated into individual integrated circuit modules, or multiple modules or steps can be fabricated into a single integrated circuit module. The disclosure is not limited to any specific combination of hardware and software.

The above descriptions are merely exemplary embodiments and should not be construed as limiting. Those skilled in the art will appreciate that various modifications and changes can be made within the spirit and principles of this application. Any modification, equivalent replacement, or improvement made within the scope of the application should fall within the protection of this application.

Although specific embodiments of the disclosure have been described in conjunction with the accompanying drawings, this does not limit the scope of the protection of this disclosure. Those skilled in the art should understand that various modifications or transformations made based on the technical solutions of this disclosure, without requiring inventive labor, still fall within the protection scope of this disclosure.

1. A visual security encryption method based on color traffic images, comprising the steps of:
generating parameters and initial values for a two-dimensional chaotic map based on color traffic image information;
performing sparsification processing on the color traffic image;
generating a measurement matrix via a chaotic system, and optimizing the measurement matrix using singular value decomposition (SVD) and column vector normalization;
applying three-dimensional spiral scrambling to the sparsified color traffic image to obtain an encrypted image;
compressing the encrypted image using the optimized measurement matrix to obtain a compressed encrypted image;
performing an integer wavelet transform (IWT) on a carrier image and embedding the compressed encrypted image into the lowest bits of the high-frequency components of the carrier image to generate a final encrypted image.

2. The method of claim 1, wherein generating the parameters and initial values for the two-dimensional chaotic map based on the color traffic image information comprises:
obtaining a 512-bit hash key KeyVal from the original color traffic image using a SHA-512 function;
performing an XOR operation between KeyVal and an external key KeyHex to generate a key H;
converting the key H into eight sub-keys k via following formula:
$$k ( i ) = \sqrt[8]{H ( i ) ⊕ H ( i + 1 ) ⊕ H ( i + 2 ) ⊕ H ( i + 3 )} , i = 1 , 2 , … , 8$$
where ⊕ denotes a bitwise XOR operation;
deriving chaotic system parameters a, delta, and initial values key1 and key2 using the sub-keys k, via:
$$\{ \begin{matrix}a = mod ( sqrt ( k ( 1 ) \times k ( 2 ) ) , 5 ) \\ key 1 = mod ( sqrt ( k ( 3 ) \times k ( 4 ) ) , 5 ) + 20 \\ key 2 = mod ( sqrt ( k ( 5 ) \times k ( 6 ) ) , 1 ) \\ delta = mod ( sqrt ( k ( 7 ) \times k ( 8 ) ) \times row , 5 ) + 0.5\end{matrix}$$

3. The method of claim 1, wherein performing sparsification processing on the color traffic image comprises:
decomposing the original color traffic image into three channels Iᵣ, I_{g}, and I_{b};
applying discrete wavelet transform (DWT) to each of Iᵣ, I_{g}, and I_{b} to generate three sparse matrices;
performing threshold processing on the sparse matrices by setting elements below a threshold TS=25 to zero, resulting in sparsified channels I′ᵣ, I′_{g}, and I′_{b}.

4. The method of claim 1, wherein generating the measurement matrix via the chaotic system comprises:
iterating the chaotic system with parameters a, key1, and key2 for len+N cycles;
discarding the first N sequences to eliminate transient effects of the chaotic mapping, thereby obtaining a chaotic sequence X of length len;
reshaping X into a matrix Φ and performing a tensor product operation between Φ and an invertible matrix to generate the measurement matrix M:
$$M = Φ ∝ {I}_{2} .$$

5. The method of claim 1, wherein optimizing the measurement matrix using SVD and column vector normalization comprises:
decomposing M via SVD to obtain a diagonal matrix Σ with diagonal elements Σ₁;
calculating the mean value of Σ₁ and assigning this mean to all diagonal elements of Σ₁ to generate a diagonal matrix Σ′;
decomposing the diagonal matrix Σ′ via SVD to obtain an optimized measurement matrix M′;
applying column vector normalization to M′ to obtain a measurement matrix M″:
$$M = U Σ {V}^{T}$$
$$where Σ = [ \begin{matrix}{Σ}_{1} & 0 \\ 0 & 0\end{matrix} ] ,$$
$${Σ}_{1} = diag ( {δ}_{1} , {δ}_{2} , {…δ}_{r} ) {δ}_{1} \geq {δ}_{2} \geq … \geq {δ}_{r} > 0 ;$$
$${M}^{′} = U {Σ}^{′} {V}^{T} .$$

6. The method of claim 3, further comprising, prior to three-dimensional spiral scrambling:
generating a chaotic sequence z1 via the chaotic system;
applying z1 to dynamically perform Arnold scrambling on the sparsified channels I′r, I′g, and I′b.

7. The method of claim 1, wherein performing three-dimensional spiral scrambling on the sparsified color traffic image comprises:
treating the three channels of the image as three faces of a cube;
applying spiral transformation scrambling starting from an upper-right corner to generate the encrypted image.

8. The method of claim 1, wherein performing IWT on the carrier image comprises:
decomposing a carrier image C into three channels Cᵣ, C_{g}, and C_{b};
applying IWT to each channel to obtain sub-bands LL, LH, HL, and HH;
separating an encrypted image S into channels Sᵣ, S_{g}, and S_{b};
converting the ith pixel of Sr into an 8-bit binary value b8b7b6b5b4b3b2b1, and converting the sub-bands LH, HL and HH of the channel Cᵣ into binary format;
embedding b2b1 into the lowest 2 bits of LH, b4b3 into the lowest bits of HL, and b8b7b6b5 into lowest 4 bits of HH, thereby obtaining HH′, LH′ and HL′;
performing an inverse wavelet transform on HH′, LH′ and HL′ to generate a visually secure carrier image C′.

9. A visual security encryption system based on color traffic images, comprising:
a parameter acquisition module configured to generate parameters and initial values for a two-dimensional chaotic map based on color traffic image information;
a sparsification module configured to perform sparsification processing on the color traffic image;
an optimization module configured to generate and optimize a measurement matrix using a chaotic system, SVD, and column vector normalization;
a scrambling module configured to apply three-dimensional spiral scrambling to the sparsified image to generate an encrypted image;
a compression module configured to compress the encrypted image using the optimized measurement matrix; and
an encryption module configured to perform IWT on a carrier image and embed the compressed encrypted image into the least significant bits of the carrier image's high-frequency components.

10. A computer device comprising: a memory, a processor, and a computer program stored on the memory and executable by the processor, wherein the processor executes the computer program to implement the visual security encryption method based on color traffic images, wherein the visual security encryption method comprises steps of:
generating parameters and initial values for a two-dimensional chaotic map based on color traffic image information;
performing sparsification processing on the color traffic image;
generating a measurement matrix via a chaotic system, and optimizing the measurement matrix using singular value decomposition (SVD) and column vector normalization;
applying three-dimensional spiral scrambling to the sparsified color traffic image to obtain an encrypted image;
compressing the encrypted image using the optimized measurement matrix to obtain a compressed encrypted image;
performing an integer wavelet transform (IWT) on a carrier image and embedding the compressed encrypted image into the lowest bits of the high-frequency components of the carrier image to generate a final encrypted image.
